(19) United States
(12) Patent Application Publication
(10) Pub. No.: US 2024/0184531 A1
(43) Pub. Date: Jun. 6, 2024

(54) STOCHASTIC COMPUTING METHOD AND CIRCUIT, CHIP AND DEVICE

(71) Applicants: Beijing BOE Technology Development Co., Ltd., Beijing (CN); BOE Technology Group Co., Ltd., Beijing (CN)

(72) Inventors: Xiangye WEI, Beijing (CN); Liming XIU, Beijing (CN)

(21) Appl. No.: 18/284,791

(22) PCT Filed: Jan. 4, 2023
(86) PCT No.: PCT/CN2023/070263

§ 371 Date: Sep. 28, 2023

(30) Foreign Application Priority Data
Jan. 12, 2022 (CN) 202210033674.6

(51) Int. Cl. G06F 7/70

(52) U.S. Cl. CPC G06F 7/70

(57) ABSTRACT

A stochastic computing method and circuit, a chip and a device are provided. The stochastic computing circuit includes: a control circuit, configured to input a control parameter into a pulse output circuit, the control parameter including a control word having an integer part and a decimal part; the pulse output circuit, configured to input a pulse to be computed into a computing circuit according to the control parameter, the pulse to be computed including at least one of a first sub-pulse and a second sub-pulse, and the periods of the sub-pulses being controlled by the integer part, and the probabilities that the sub-pulses appear in the pulse to be computed being controlled by the decimal part; and the computing circuit, configured to perform logic computing according to the duty cycle of the pulse to be computed and output a computing result.

The present application is a National Stage of International Application No. PCT/CN2023/070263 filed on Jan. 4, 2023, which claims priority to Chinese Patent Application No. 202210033674.6, filed on Jan. 12, 2022 and entitled “STOCHASTIC CALCULATION METHOD, CIRCUIT, CHIP AND DEVICE”, the contents of both of which are incorporated herein by reference in their entirety.

### TECHNICAL FIELD

The present application relates to the field of circuit technologies, and in particular relates to a stochastic computing method and circuit, a chip and a device.

### BACKGROUND OF THE INVENTION

The computing circuit is an important component of processing chips such as a central processing unit (CPU) and a graphics processing unit (GPU) and is configured to perform logical computing.

In the related art, based on binary computing, the computing circuit converts numbers to be computed from decimal to binary, and then computes the binary numbers.

However, when certain bit of the binary number is wrong, the binary number will undergo a significant change, resulting in a relatively great difference between a computing result output by the computing circuit and a correct computing result and thus relatively low accuracy of the computing result output by the computing circuit.

### SUMMARY OF THE INVENTION

The present application provides a stochastic computing method and circuit, a chip and a device.

In a first aspect, a stochastic computing circuit is provided. The stochastic computing circuit includes a control circuit, a pulse output circuit and a computing circuit, wherein both the control circuit and the computing circuit are connected to the pulse output circuit;

the control circuit is configured to input a control parameter into the pulse output circuit, the control parameter including a control word having an integer part and a decimal part;

the pulse output circuit is configured to input a pulse to be computed into the computing circuit according to the control parameter and multiple reference pulses having evenly spaced phases, the pulse to be computed including at least one of a first sub-pulse and a second sub-pulse distributed at a time domain, and periods of the first sub-pulse and the second sub-pulse being controlled by the integer part, and the probabilities that the first sub-pulse and the second sub-pulse appear in the pulse to be computed being controlled by the decimal part; and

the computing circuit is configured to perform logic computing according to a duty cycle of the pulse to be computed and output a computing result of the logic computing.

In some embodiments, the control parameter further includes a high-level parameter ξ; T_{HI_A}=T_{HI_B}=ξ*Δ, wherein

T_{HI_A} represents a duration of a high-level of the first sub-pulse; T_{HI_B} represents a duration of a high-level of the second sub-pulse; ξ is an integer, 1≤ξ≤I-1, and I represents the integer part; and Δ represents a phase difference between any two adjacent reference pulses among the multiple reference pulses.

In some embodiments, the stochastic computing circuit includes a plurality of pulse output circuits, wherein

the control circuit is configured to input the control parameter corresponding to each of the pulse output circuits into the corresponding pulse output circuit.

In some embodiments, the plurality of pulse output circuits includes: a first pulse output circuit configured to input a first pulse to be computed to the computing circuit, and a second pulse output circuit configured to input a second pulse to be computed into the computing circuit,

the first pulse to be computed being uncorrelated with the second pulse to be computed.

In some embodiments, the first pulse to be computed and the second pulse to be computed are independent of each other.

In some embodiments, a target parameter of the first pulse to be computed and a target parameter of the second pulse to be computed are mutually prime; and

for any pulse to be computed, the target parameter of the pulse to be computed is q*I+p, p/q being equal to the decimal part and I representing the integer part.

In some embodiments, the stochastic computing circuit further includes: a sampling circuit and a clock circuit, wherein both the computing circuit and the clock circuit are connected to the sampling circuit; the sampling circuit is further connected to the control circuit;

the control circuit is further configured to input a target sequence length into the sampling circuit;
the clock circuit is configured to provide a clock signal to the sampling circuit;
the sampling circuit is configured to acquire a result sequence having the target sequence length by sampling the computing result output by the computing circuit according to the clock signal and the target sequence length; and
the sampling circuit is further configured to output an indicator signal of a duty cycle of the result sequence.

In some embodiments, a duration of the pulse to be computed TFD=(q−p)*TA+p*TB, wherein

p/q is equal to the decimal part; T_{A}=I*Δ, T_{A} representing the period of the first sub-pulse, I representing the integer part, and A representing a phase difference between any two adjacent reference pulses among the multiple reference pulses; and T_{B}=(I+1)*Δ, T_{B} representing the period of the second sub-pulse.

In some embodiments, p/q is a fraction in lowest terms of the decimal part.

In some embodiments, the integer part is greater than 16.

In some embodiments, the pulse output circuit includes: a first processing circuit, a second processing circuit and an output circuit, wherein both the first processing circuit and the output circuit are connected to the second processing circuit;
the first processing circuit is configured to output a first control signal and a second control signal according to the control parameter;
the second processing circuit is configured to select an I-th reference pulse from the multiple reference pulses according to the first control signal, select a J-th reference pulse from the multiple reference pulses according to the second control signal, and select one of the I-th reference pulse and the J-th reference pulse as an output pulse, 1≤I, and 1≤J; and
the output circuit is configured to output the pulse to be computed according to the output pulse of the second processing circuit.

In some embodiments, the logic computing includes at least one of addition, subtraction, multiplication, division, square root, and square.

In a second aspect, a stochastic computing method is provided. The method is used for any stochastic computing circuit provided in the first aspect. The method includes:
inputting, by the control circuit, the control parameter into the pulse output circuit, the control parameter comprising a control word having an integer part and a decimal part;
inputting, by the pulse output circuit, the pulse to be computed into the computing circuit according to the control parameter and the multiple reference pulses having evenly spaced phases, the pulse to be computed including at least one of the first sub-pulse and the second sub-pulse distributed in the time domain, and the periods of the first sub-pulse and the second sub-pulse being controlled by the integer part, and the probabilities that the first sub-pulse and the second sub-pulse appear in the pulse to be computed being controlled by the decimal part; and
performing, by the computing circuit, logic computing according to the duty cycle of the pulse to be computed and outputting, by the computing circuit, the computing result of the logic computing.

In a third aspect, a chip is provided. The chip includes any stochastic computing circuit provided in the first aspect.

In a fourth aspect, an electronic device is provided. The electronic device includes the chip provided in the third aspect.

### BRIEF DESCRIPTION OF DRAWINGS

FIG. 1 is a structural schematic diagram of a stochastic computing circuit according to an embodiment of the present application;

FIG. 2 is a waveform diagram of multiple reference pulses provided by a signal source according to an embodiment of the present application;

FIG. 3 is a schematic diagram of a pulse to be computed according to an embodiment of the present application;

FIG. 4 is a schematic diagram of a value range of D_{FD} p under different I values according to an embodiment of the present application;

FIG. 5 is a structural schematic diagram of a pulse output circuit 02 according to an embodiment of the present application;

FIG. 6 is a structural schematic diagram of another stochastic computing circuit according to an embodiment of the present application;

FIG. 7 is a structural schematic diagram of still another stochastic computing circuit according to an embodiment of the present application;

FIG. 8 is a structural schematic diagram of yet still another stochastic computing circuit according to an embodiment of the present application;

FIG. 9 is a graph of results of Example 1 in table 1 according to an embodiment of the present application;

FIG. 10 is a graph of results of Example 2 in table 1 according to an embodiment of the present application; and

FIG. 11 is a flowchart of a stochastic computing method according to an embodiment of the present application.

### DETAILED DESCRIPTION

For clearer descriptions of the principle, technical solutions and advantages in the present application, the embodiments of the present application are described in detail below with reference to the accompanying drawings.

As the chip technology develops by leaps and bounds and the IoT application is implemented gradually, the computing of computing circuits in chips has become increasingly complex, and a computing paradigm (also known as a computing method) used by the computing circuits needs to be broken through.

In the related art, the computing circuit uses the typical von Neumann architecture. In addition, based on binary computing, the computing circuit converts numbers needing to be computed from decimal to binary, and then computes the binary numbers. For example, assuming that the product of 3 and 8 needs to be computed, the computing circuit will convert 3 to binary numbers 0011 and 8 to binary numbers 0100, and then multiplies 0011 by 0100 to acquire a computing result 24.

However, when certain bit of the binary number is wrong, the binary number will undergo a significant change, resulting in a relatively great difference between a computing result output by the computing circuit and a correct computing result and thus relatively low accuracy of the computing result output by the computing circuit. For example, again assuming that the product of 3 and 8 needs to be computed, when a second bit in the binary number 0011 of 3 is wrong, the binary number becomes 0111 indicating 12 which significantly differs from 3, and a result acquired by multiplying the binary number 0111 representing 12 by the binary number 0100 representing 8 is 96 which significantly differs from 24.

In addition, the computing accuracy of this computing method is absolutely related to the number of binary bits. As the computing task intensifies, the number of binary bits reaches 64, 128, 256, and 1024. The computing accuracies of the computing circuits using different numbers of binary bits are different. If the computing circuit needs to be compatible with multiple computing accuracies, the design cost of the computing circuit increases. If the computing circuit is not compatible with multiple computing accuracies, the computing circuit only has a fixed accuracy and thus poor scalability.

Furthermore, before the computing circuit performs computing, a processor where the computing circuit is disposed needs to read data to be computed of the computing circuit from a memory. It can be seen that the computing efficiency of the computing circuit is related to the bandwidths of the processor and the memory, and a lower bandwidth of the bandwidths of the processor and the memory negatively affects the computing efficiency of the computing circuit.

Embodiments of the present application provide a stochastic computing circuit. The accuracy of computing results output by the stochastic computing circuit is relatively high, and the stochastic computing circuit can have infinite computing accuracies and the bandwidth of a memory does not affect the computing efficiency of the stochastic computing circuit.

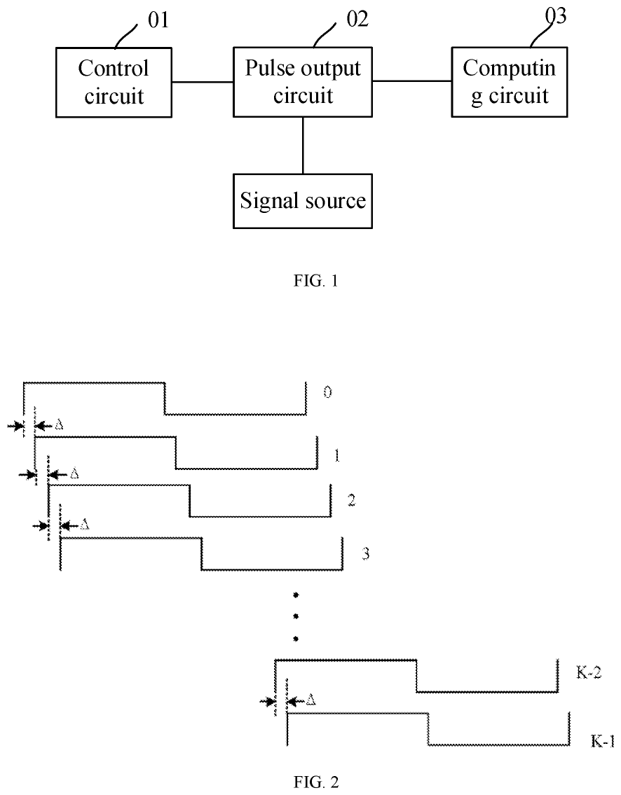

In an exemplary embodiment, FIG. 1 is a structural schematic diagram of a stochastic computing circuit according to an embodiment of the present application. As shown in FIG. 1, the stochastic computing circuit includes a control circuit 01, a pulse output circuit 02 and a computing circuit 03. The control circuit 01 and the computing circuit 03 are both connected to the pulse output circuit 02.

The control circuit 01 is configured to input a control parameter into the pulse output circuit 02. The control parameter includes a control word having an integer part and a decimal part. The control word is a number and has the integer part and the decimal part. For example, the control word is 2.5 having the integer part 2 and the decimal part 0.5. It should be noted that when the control word is an integer, the decimal part of the control word is 0.

The pulse output circuit 02 is configured to input a pulse to be computed into the computing circuit 03 according the control parameter and multiple reference pulses having evenly spaced phases. The pulse to be computed includes at least one of a first sub-pulse and a second sub-pulse which are distributed in a time domain. Periods of the first sub-pulse and the second sub-pulse are controlled by the integer part, and the probabilities that the first sub-pulse and the second sub-pulse appear in the pulse to be computed are controlled by the decimal part.

With continued reference to 1, the multiple reference pulses having evenly spaced phases may be pulses provided by a signal source. The signal source may be disposed outside the pulse output circuit 02. Certainly, the signal source may also belong to the pulse output circuit 02. In the embodiments of the present application, that the signal source is disposed outside the pulse output circuit 02 is taken as an example.

FIG. 2 is a waveform diagram of multiple reference pulses provided by a signal source. In FIG. 2, that the multiple reference pulses include k reference pulses is taken as an example, where K>1. With reference to FIG. 2, the multiple reference pulses have the same waveform (i.e., the same period and amplitude). The waveforms of the multiple reference pulses are distributed evenly and theses pulses are equidistantly spaced in the time domain. A phase difference between any two adjacent reference pulses among the multiple reference pulses is A and the frequency of each of the multiple reference pulses is fi.

The control parameter is configured to control the pulse to be computed output by the pulse output circuit 02.

In an exemplary embodiment, a duty cycle of the pulse to be computed is configured to represent a decimal to be computed, i.e., a decimal to be involved in computing. The stochastic computing circuit provided by the embodiments of the present application is configured to perform logic computing on the decimal. For example, if the decimal to be computed is 0.5, the duty cycle of the pulse to be computed output by the pulse output circuit 02 is ½. That is, the proportion of a duration of a high level in the pulse to be computed is ½ and the pulse to be computed may be 11110000.

In an another exemplary embodiment, the periods of the first sub-pulse and the second sub-pulse in the pulse to be computed are controlled by the integer part, and the probabilities that the first sub-pulse and the second sub-pulse in the pulse to be computed appear in the pulse to be computed are controlled by the decimal part. For example, assuming that the period of the first sub-pulse is represented by T_{A}, the period of the second sub-pulse is represented by TB and the integer part of the control word is represented by I, T_{A}=I*Δ and T_{B}=(I+1)*Δ. Certainly, T_{A} and TB may also have other representations, such as T_{B}=(I+2)*Δ, etc., and T_{A}=I*Δ and T_{B}=(I+1)*Δ are taken as an example in the embodiments of the present application. If the decimal part of the control word is represented by r, the ratio of the probabilities that the first sub-pulse and the second sub-pulse appear in the pulse to be computed is (q−p)/p and p/q=r. In this case, the duration of the pulse to be computed is T_{FD}=(q−p)*T_{A}+p*T_{B} and p/q may be a fraction in lowest terms of the decimal part r. For example, assuming that the decimal part is 0.5, p/q is ½, p=1 and q=2. P/q may also not be a fraction in lowest terms of the decimal part r. For example, when the decimal part is 0.5, p=2 and q=4.

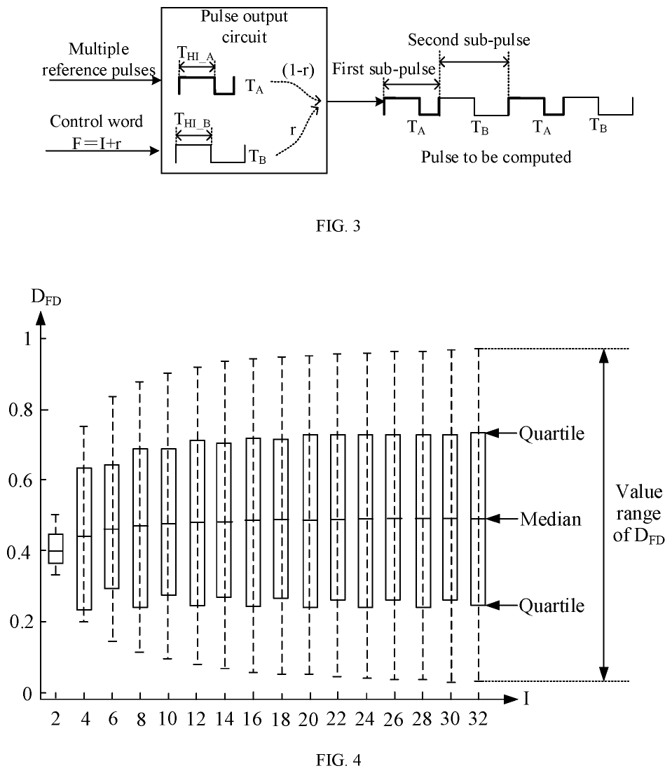

As shown in FIG. 3, the period T_{B} is greater than the period T_{A}, which is shown as the length of T_{B} being greater than that of T_{A} in FIG. 3. When the decimal part of the control word is 0.5, the probabilities that the first sub-pulse and the second sub-pulse appear in the pulse to be computed are equal, and the probabilities that T_{A} and T_{B} appear are equal. With reference to the pulse to be computed shown in FIG. 3, T_{A} and T_{B} appear alternately. When the decimal part is less than 0.5, the probability that the first sub-pulse appears in the pulse to be computed is greater than the probability that the second sub-pulse appears in the pulse to be computed and the probability that T_{A} appears is greater than the probability that T_{B} appears. When the decimal part is greater than 0.5, the probability that the first sub-pulse appears in the pulse to be computed is less than the probability that the second sub-pulse appears in the pulse to be computed and the probability that T_{B} appears is greater than the probability that T_{A} appears. It should be noted that when the control word is an integer, the decimal part of the control word is 0. In this case, the pulse signal only contains the first sub-pulse, but does not contain the second sub-pulse.

The computing circuit 03 is configured to perform logic computing according the duty cycle of the pulse to be computed and output a computing result of the logic computing. The pulse output circuit 02 will input the pulse to be computed into the computing circuit 03, and the computing circuit 03 may perform logic computing according to the duty cycle (representing the decimal to be computed) of the pulse to be computed (equivalent to performing logic computing according to the decimal to be computed). For example, if the duty cycle of the pulse to be computed is ½, the computing circuit 03 may perform logic computing according to ½. The logic computing here may be any logic computing. For example, the logic computing includes at least one of addition, subtraction, multiplication, division, square root, and square. When the logic computing includes addition, the computing circuit 03 includes an OR gate, or a data multiplexer (MUX), etc.

In summary, in the stochastic computing circuit provided by the embodiments of the present application, the pulse output circuit can output the pulse to be computed and the computing circuit can perform logic computing according to the duty cycle of the pulse to be computed. When certain bit in the pulse to be computed is wrong, the duty cycle of this pulse to be computed does not change significantly and thus the logic computing result does not change significantly. Therefore, the accuracy of the computing result output by the computing circuit is relatively high.

In addition, the control circuit may control the duty cycle of the pulse to be computed output by the pulse output circuit, the periods of the sub-pulses and the probabilities that the sub-pulses appear, via the control word. Therefore, precise control on the pulses to be computed can be achieved.

The duration of the pulse to be computed is T_{FD}=(q−p)*·T_{A}+p*T_{B}, and assuming that the period of the pulse to be computed is T_{TAF},

$${T}_{FD} = q \cdot {T}_{TAF} = ( q - p ) \cdot {T}_{A} + p \cdot {T}_{B} = ( q \cdot I + p ) \cdot Δ ; \\ {T}_{TAF} = \frac{1}{{f}_{s}} = ( 1 - r ) \cdot {T}_{A} + r \cdot {T}_{B} = ( I + r ) \cdot Δ = F \cdot Δ ; \\ {df}_{s} = - \frac{dF}{{F}^{2} Δ} = - \frac{dF}{F} \cdot \frac{1}{F Δ} = - \frac{dF}{F} \cdot {f}_{s} ; and \\ \frac{{df}_{s}}{{f}_{s}} = - \frac{dF}{F} ,$$

wherein F represents the control word and F=I+r. It can be seen that fs (a frequency of the pulse to be computed) changes linearly with the change of F, and accordingly, the period of the pulse to be computed will also change with the change of F. Therefore, in the embodiments of the present application, the period and the frequency of the pulse to be computed may be controlled via the control word.

In the above embodiment, that the control parameter input by the control circuit 01 into the pulse output circuit 02 includes the control word is taken as an example. In some embodiments, the control parameter further includes a high-level parameter ξ. The high-level parameter ξ is configured to control high-level durations of the first sub-pulse and the second sub-pulse in the pulse to be computed. T_{HI_A}=T_{HI_B}=ξ*Δ, wherein T_{HI_A} represents the high-level duration of the first sub-pulse; H_{I_B} represents a duration of a high-level of the second sub-pulse; ξ is an integer, 1≤ξ≤I-1, and I represents the integer part; and A represents a phase difference between any two adjacent reference pulses among the multiple reference pulses. As shown in FIG. 3, the high-level duration T_{HI_A} of the first sub-pulse is equal to the high-level duration T_{HI_B} of the second sub-pulse.

When T_{HI_A}=T_{HI_B}=ξ*Δ, the total time T_{HI_FD} of high levels in the pulse to be computed may be expressed as:

T_{HI_FD}=(q−p)·ξ·Δ+p·ξ·Δ=q·ξ·Δ;

the proportion D_{FD} of the high levels in the pulse to be computed may be expressed as:

$${D}_{FD} = \frac{{T}_{HI \_ FD}}{{T}_{FD}} = \frac{q \cdot ζ \cdot Δ}{( q \cdot I + p ) \cdot Δ} = \frac{q \cdot ζ}{( q \cdot I + p )} = \frac{ζ}{I + p / q} = \frac{ζ}{I + r} ;$$

and

according to 1≤ξ≤I-1, it can be concluded that the value range of D_{FD} is:

$$\frac{q}{q \cdot I + p} = \frac{1}{I + r} \leq {D}_{FD} \leq \frac{I - 1}{I + r} = \frac{q \cdot ( I - 1 )}{q \cdot I + p} .$$

By deducing the value range of D_{FD} mentioned above, it can be concluded that:

$$\frac{1}{I + 1} < {D}_{FD} \leq \frac{I - 1}{I} .$$

It can be seen form this value range of D_{FD} that the value range of D_{FD} may almost cover the entire range from 0 to 1. For example, when I=128, the value range of D_{FD} is as follows:

$$\frac{1}{129} < {D}_{FD} \leq \frac{127}{128} .$$

In an exemplary embodiment, the value ranges of D_{FD} under different I values are shown in FIG. 4. It can be seen that when I>16, the value range of D_{FD} may almost cover the entire range from 0 to 1. I>16 is taken as an example in the embodiments of the present application.

When the value range of D_{FD} may almost cover the entire range from 0 to 1, the decimal represented by the pulse to be computed may almost cover the entire range from 0 to 1. Thus, the stochastic computing circuit has a relatively large application range.

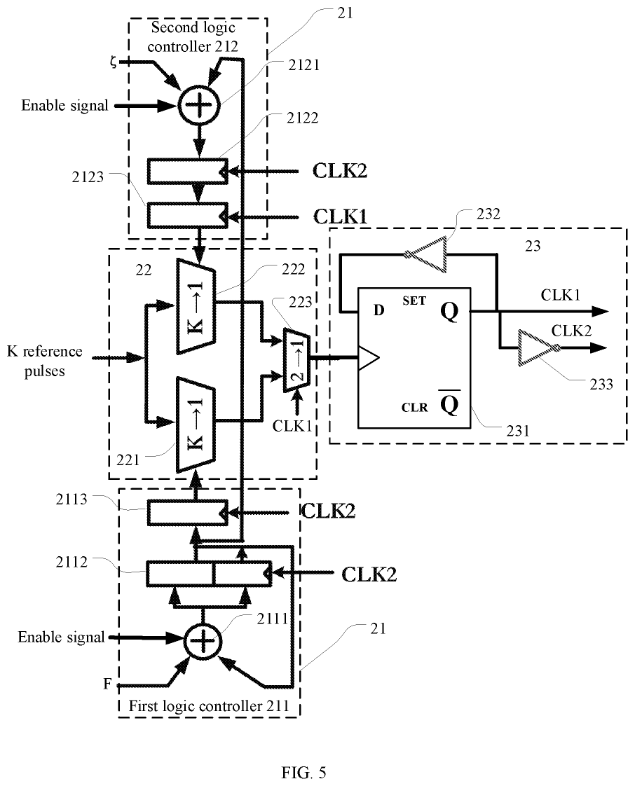

Further, the pulse output circuit 02 provided by the embodiments of the present application has various structures and the following description is given by taking the pulse output circuit using the structure in FIG. 5 as an example. With reference to FIG. 5, the pulse output circuit 02 includes a first processing circuit 21, a second processing circuit 22 and an output circuit 23. The first processing circuit 21 and the output circuit 23 are both connected to the second processing circuit 22.

The first processing circuit 21 is configured to output a first control signal and a second control signal according the control parameter. The second processing circuit 22 is configured to select an I-th reference pulse from the multiple reference pulses (such as K reference pulses, wherein K>1) according to the first control signal, select a J-th reference pulse from the multiple reference pulses according to the second control signal, and select one of the I-th reference pulse and the J-th reference pulse as an output pulse, wherein 1≤I, and 1≤J. The output circuit 23 is configured to output the pulse be computed according the output pulse of the second processing circuit 22.

The following describes working processes of the first processing circuit 21, the second processing circuit 22 and the output circuit 23 with reference to FIG. 5.

The first processing circuit 21 includes a first logic controller 211 and a second logic controller 212.

With reference to FIG. 5, the first logic controller 211 includes a first adder 2111, a first register 2112, and a second register 2113. The first register 2112 is connected to the first adder 2111 and the second register 2113. The first logic controller 211 serves to generate the first control signal.

The first adder 2111 is configured to add the control word F and the most significant bit (for example, 5 bits) stored in the first register 2112 under the action of an enable signal, and then save the sum into the first register 2112 at a rising edge of a second clock frequency CLK2. Alternatively, the first adder 2111 may be configured to add the control word F and all bits stored in the first register 2112 under the action of the enable signal, and then save the sum into the first register 2112 at the rising edge of the second clock frequency CLK2. At the next rising edge of the second clock frequency CLK2, the most significant bit stored in the first register 2112 will be stored in the second register 2113 as a selection signal, i.e., the aforementioned first control signal, of a first K→1 multiplexer 221, which is configured to select the I-th reference pulse from the K reference pulses having evenly spaced phases and output the same.

When the control word F and the most significant bit stored in the first register 2112 are added, assuming that a value in the first register 2112 is less than 1, if the decimal part of the sum carries, the most significant bit stored in the second register 2113 is I+1; and if no carry occurs in the control word when adding, the most significant bit stored in the second register 2113 is I. When the most significant bit stored in the second register 2113 is I+1, the pulse output circuit correspondingly outputs T_{B}=(I+1)*Δ; and when the most significant bit stored in the second register 2113 is I, the pulse output circuit correspondingly outputs T_{A}=I*Δ. It can be seen that whether T_{A} or T_{B} is output is related to the size of the decimal part of the control word. The smaller the decimal part of the control word is, the low possibility the carry occurs, the higher the probability that T_{A} is output is, and vice versa, the higher the probability that T_{B} is output is.

Here, the first register 2112 may include a first part storing an integer and a second part storing a decimal. When adding, the integer part of the control word F is added to the content in the first part, and the decimal part of the control word F is added to the content in the second part. The addition is binary addition, which is implemented by the adder.

The second logic controller 212 includes a second adder 2121, a third register 2122 and a fourth register 2123. The third register 2122 is connected to the second adder 2121 and the fourth register 2123. The second logic controller 212 serves to generate the second control signal.

The second adder 2121 is configured to add the high-level parameter (and the most significant bit stored in the first register 2112 under the action of the enable signal, and then save the sum to the third register 2122 at the rising edge of the second clock frequency CLK2. After the sum is saved to the third register 2122, at a rising edge of a first clock frequency CLK1, information stored in the third register 2122 will be stored in the fourth register 2123 as a selection signal, i.e., the aforementioned second control signal, of a second K→1 multiplexer 222, which is configured to select the J-th reference pulse from the K reference pulses and output the same. The second clock frequency CLK2 is a signal acquired after the first clock frequency CLK1 passes through a NOT gate.

It should be noted that in the embodiments of the present application, that the input of the second adder 2121 includes the high-level parameter ξ is taken as an example. In some embodiments, the high-level parameter ξ in the input of the second adder 2121 may also be other parameters for controlling T_{HI_A} and T_{HI_B}, which is not limited in the embodiments of the present application.

With reference to FIG. 5, the second processing circuit 22 includes the first K→1 multiplexer 221, the second K→1 multiplexer 222 and a 2→1 multiplexer 223. The first K→1 multiplexer 221 and the second K→1 multiplexer 222 each include a plurality of input terminals, a control input terminal and an output terminal. The 2→1 multiplexer 223 includes a control input terminal, an output terminal, a first input terminal and a second input terminal. The output terminal of the first K→1 multiplexer 221 is connected to the first input terminal of the 2→1 multiplexer 223, and the output terminal of the second K→1 multiplexer 222 is connected to the second input terminal of the 2→1 multiplexer 222. The plurality of input terminals of the first K→1 multiplexer 221 and the plurality of input terminals of the second K→1 multiplexer 222 are all connected to a signal generator. The control input terminal of the first K→1 multiplexer 221 is connected to the second register 2113 and the control input terminal of the second K→1 multiplexer 222 is connected to the fourth register 2123.

The control input terminal of the first K→1 multiplexer 221 selects the I-th reference pulse from the K reference pulses having evenly spaced phases and outputs the same under the control of the first control signal generated by the first logic controller 211. The control input terminal of the second K→1 multiplexer 221 selects the J-th reference pulse from the K reference pulses having evenly spaced phases and outputs the same under the control of the second control signal generated by the second logic controller 211.

By taking the first K→1 multiplexer as an example, when the reference pulse is selected, it may be selected according to the value stored in the second register 2113, i.e., the value of the first control signal. For example, if the first control signal is 3, the third reference pulse is selected from the K reference pulses having evenly spaced phases and output.

The 2→1 multiplexer 223 may select one of the I-th reference pulse output by the first K→1 multiplexer 221 and the J-th reference pulse output by the second K→1 multiplexer 222 at the rising edge of the first clock frequency CLK1 as the output of the 2→1 multiplexer 223. For example, at the first rising edge, the I-th reference pulse is selected until the second rising edge, at the second rising edge, the J-th reference pulse is selected until the third rising edge, and so on.

Since the 2→1 multiplexer makes a selection between the outputs of the two K→1 multiplexers, the outputs of the two K→1 multiplexers are combined to form a new cycle, and a difference between the first pulse signal and the second pulse signal output by the two K→1 multiplexers is an integer number of A, including two cases, i.e., I*Δ and (I+1)*Δ, so that two different periods T_{A} and T_{B} exist in the pulse to be computed output finally by the pulse output circuit.

With reference to FIG. 5, the output circuit 23 includes a flip-flop circuit. The flip-flop circuit is configured to generate a pulse train. The flip-flop circuit includes a D flip-flop 231, a first inverter 232 and a second inverter 233. The D flip-flop 231 includes a data input terminal, a clock input terminal and an output terminal. The first inverter 232 includes an input terminal and an output terminal. The second inverter 233 includes an input terminal and an output terminal. The clock input terminal of the D flip-flop 231 is connected to the 2→1 multiplexer 223, the data input terminal of the D flip-flop 231 is connected to the output terminal of the first inverter 232, and the output terminal of the D flip-flop 231 is connected to the input terminal of the first inverter 232 and the input terminal of the second inverter 233. The output terminal of the D flip-flop 231 or the output terminal of the second inverter 233 may be used as the output terminal of the pulse output circuit, i.e., the terminal generating the pulse to be computed. Therefore, the pulse to be computed output by the pulse output circuit is the first clock frequency CLK1 or the second clock frequency CLK2 in FIG. 5.

In the embodiments of the present disclosure, a first clock signal and a second clock signal are the first clock frequency CLK1 output by the pulse output circuit when different control words are input. Alternatively, the first clock signal and the second clock signal are the second clock frequency CLK2 output by the pulse output circuit when different control words are input.

The clock input terminal of the D flip-flop 231 receives the output from the output terminal of the 2→1 multiplexer 223, and the D flip-flop 231 outputs the first clock frequency CLK1 through the output terminal. The input terminal of the first inverter 232 receives the first clock frequency CLK1, and the first inverter 232 outputs an output signal to the data input terminal of the D flip-flop 231. The input terminal of the second inverter 233 receives the first clock frequency CLK1, and the second inverter 233 outputs the second clock frequency CLK2 through the output terminal.

The pulse output circuit provided by the embodiments of the present application may be called a fixed-probability random number generator, such as a fixed-probability random number generator based on a time-average-frequency direct period synthesis (TAF-DPS) circuit.

The phase difference Δ between any two adjacent reference pulses among the multiple reference pulses may be adjusted. When Δ is relatively large, the power consumption of the stochastic computing circuit is relatively low; and when Δ is relatively small, the computing efficiency and performance of the stochastic computing circuit are relatively high.

Further, in the above embodiment, that the stochastic computing circuit includes one pulse output circuit 02 is taken as an example. In some embodiments, the stochastic computing circuit provided by the embodiments of the present application may also include a plurality of pulse output circuits 021. In this case, the control circuit 01 is configured to input the control parameter corresponding to each of the pulse output circuits 02 into the corresponding pulse output circuit 02. The control parameters corresponding to different pulse output circuits 02 may be the same or different, which is not limited in the embodiments of the present application.

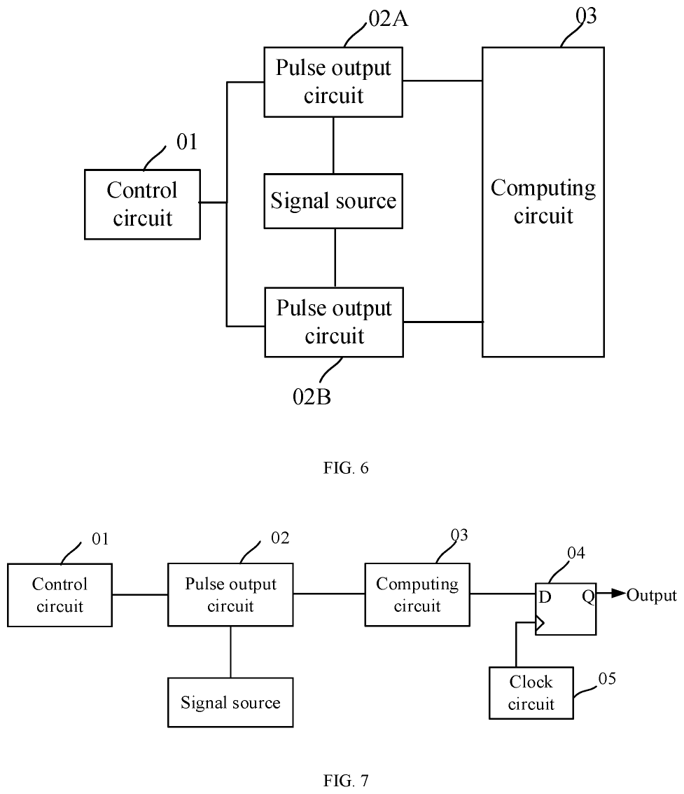

In an exemplary embodiment, that the plurality of pulse output circuits includes a first pulse output circuit 02A and a second pulse output circuit 02B is taken as an example. As shown in FIG. 6, the first pulse output circuit 02A and the second pulse output circuit 02B are both connected to the control circuit 01 and the computing circuit 03. The control circuit 01 is configured to input the control parameters corresponding to the pulse output circuits respectively into these two pulse output circuits, the first pulse output circuit 02A is configured to input a first pulse to be computed into the computing circuit 03, and the second pulse output circuit 02B is configured to input a second pulse to be computed into the computing circuit 03. A duty cycle of the first pulse to be computed represents a first decimal to be computed, and a duty cycle of the second pulse to be computed represents a second decimal to be computed. The computing circuit 03 may perform logical computing on the first decimal to be computed and the second decimal to be computed. For example, by taking that the logic computing includes multiplication as an example in FIG. 6, in this case, the computing circuit 03 is an AND logic gate, and when performing the logical computing on the first decimal to be computed and the second decimal to be computed, the AND logic gate may multiply the first decimal to be computed by the second decimal to be computed.

In some embodiments, when the plurality of pulse output circuits includes the first pulse output circuit and the second pulse output circuit, the first pulse to be computed output by the first pulse output circuit is uncorrelated with the second pulse to be computed output by the second pulse output circuit. For example, the first pulse to be computed is independent of the second pulse to be computed, and when these two pulses are independent of each other, these two pulses are uncorrelated with each other.

It should be noted that in stochastic computing, when the plurality of pulses to be computed are uncorrelated, the computing circuit performs logic computing based on the duty cycles of the plurality of pulses to be computed, and the output computing result of the logic computing is relatively accurate. In the embodiments of the present application, by taking that the plurality of pulses to be computed output by the plurality of pulse output circuits includes the first pulse to be computed and the second pulse to be computed as an example, when the plurality of pulses to be computed further includes other pulses to be computed, the plurality of pulses to be computed is also uncorrelated with one another.

In some embodiments, when the first pulse to be computed is independent of the second pulse to be computed, a target parameter of the first pulse to be computed and a target parameter of the second pulse to be computed are mutually prime. For any pulse to be computed, the target parameter of the pulse to be computed is q*·I+p, p/q is equal to the decimal part, and I represents the integer part.

Assuming that the first pulse to be computed is X and the second pulse to be computed is Y, the period of X is T_{X}=(q_{X}·Iₓ+p_{X})Δ, and the period of Y is T_{Y}=(q_{Y}·I_{Y}+p_{Y})Δ. Assuming that (q_{X}·I_{X}+p_{X})Δ=Iqp_{X}·Δ, and (q_{Y}·I_{Y}+p_{Y})Δ=Iqp_{Y}·Δ, Iqp_{X} represents the target parameter of X, and Iqp_{Y} represents the target parameter of Y.

When Δ is used as a time resolution, a value set of elements in a time sequence represented by X is:

Ω_{X}={X₀, X₁, X₂, . . . , X_{IqpX-1},}, Xᵢ={0,1}, where Xᵢ represents an I-th element in the time sequence represented by X, and 0≤i≤Iqpₓ₋₁.

When X is sampled using Y, a space of the resulting time sequence is as follows:

Ω_{X|Y}={Iqp_{Y}·i mod Iqp_{X}: i∈N}, wherein mod represents the remainder computing, and N represents a natural number.

It can be seen from the above set that when Iqpₓ and Iqp_{y} are mutually prime, Ω_{X} is equal to Ω_{X|Y}, that is, Iqp_{X}⊥Iqp_{Y}⇒Ω_{X|Y}=Ω_{X}.

In this case, P(X=a)·P (Y)=P(ω_{X} ∈Ω_{X})·P (Y);

$$P ( {ω}_{X} ∈ {Ω}_{X} ) \cdot P ( Y ) = P ( {ω}_{X} ∈ {Ω}_{X} \vert {ω}_{Y} ∈ {Ω}_{Y} ) \cdot P ( Y ) = P ( X \vert Y ) \cdot P ( Y ) ; and$$

$$P ( X \vert Y ) \cdot P ( Y ) = \frac{P ( X ⋂ Y )}{P ( Y )} \cdot P ( Y ) = P ( X ⋂ Y ) .$$

Due to P (X)·P (Y)=P(X∩Y) and X and Y are independent of each other, it can be seen that when Iqpₓ and Iqp_{Y} are mutually prime, X and Y are independent of each other. Therefore, in the embodiments of the present application, Igpₓ and Iqp_{Y} may be mutually prime through the design of the control word, so that X and Y are independent of each other so as to improve the accuracy of the computing result of the logic computing output by the computing circuit.

Further, as shown in FIG. 7, the stochastic computing circuit provided by the embodiments of the present application further includes: a sampling circuit 04 and a clock circuit 05. The computing circuit 03 and the clock circuit 05 are both connected to the sampling circuit 04. For example, the computing circuit 03 is connected to a D terminal of the sampling circuit. The sampling circuit 04 is further connected to the control circuit 01 (this connection relationship is not shown in FIG. 7). The control circuit 01 is further configured to input a target sequence length into the sampling circuit 04 and the clock circuit 05 is configured to provide a clock signal to the sampling circuit 04. The sampling circuit 04 is configured to acquire a result sequence having the target sequence length by sampling the computing result output by computing circuit 03 according to the clock signal and the target sequence length; and output an indicator signal of a duty cycle of the result sequence (for example, output the indicator signal from a Q terminal). In an exemplary embodiment, the indicator signal may be all 1s (high level) and/or all 0s (low level) in the result sequence.

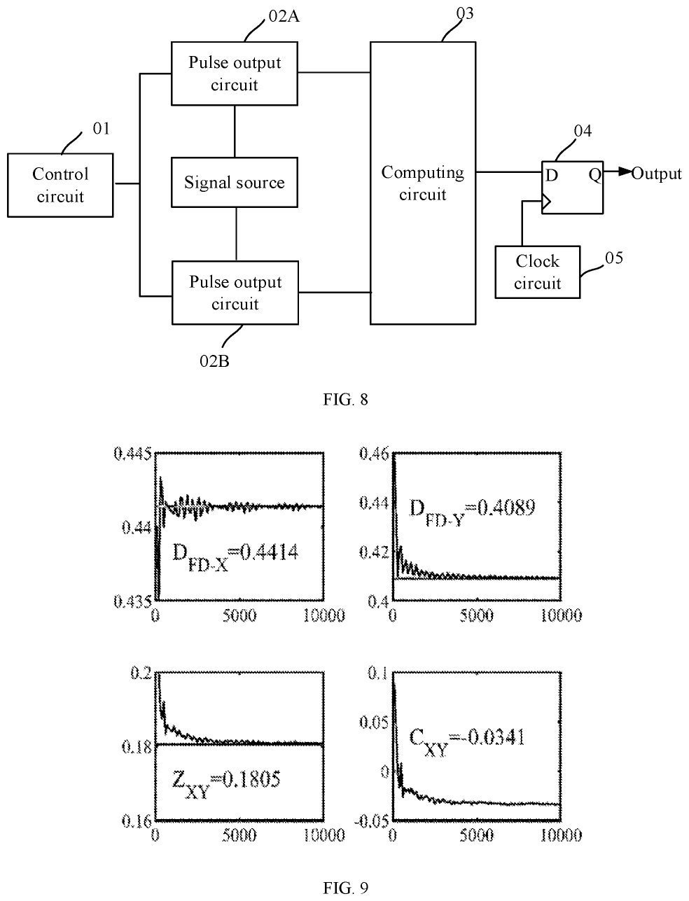

In FIG. 7, that the stochastic computing circuit further includes the sampling circuit 04 and the clock circuit 05 on the basis of FIG. 1 is taken as an example. When the stochastic computing circuit further includes the sampling circuit 04 and the clock circuit 05 on the basis of FIG. 6, the stochastic computing circuit may be as shown in FIG. 8.

It should be noted that when the longer the sequence is, the higher the precision of the decimal represented by the sequence is. Therefore, the accuracy of the computing result output by the computing circuit 03 is positively correlated with the length (target sequence length) of the result sequence acquired by sampling of the computing circuit 03. In the embodiments of the present application, the control circuit 01 may control the result sequence having the target sequence length acquired by sampling of the computing circuit 03 by inputting the target sequence length into the computing circuit 03 and thus control the accuracy of the computing result output by the computing circuit 03. It can be seen that the computing accuracy (accuracy of the computing result) of the stochastic computing circuit provided by the embodiments of the present application may be adjusted randomly, and the stochastic computing circuit can be compatible with various computing accuracies. In addition, the stochastic computing circuit can realize any computing accuracy within a limited circuit area. Therefore, the area utilization rate of the stochastic computing circuit is relatively high, and the cost of the stochastic computing circuit is relatively low.

The computing accuracy of the stochastic computing circuit refers to the ratio of a computing difference to a theoretical computing result, and the computing difference is an absolute value of a difference between an actual computing result output by the stochastic computing circuit and a theoretical computing result.

Stochastic computing is a computing paradigm proposed by von Neumann, with the most important feature that numbers may be represented by very simple bit streams that are processed by circuits, and the numbers themselves are interpreted as probabilities, that is, the probability that each bit in this bit stream is 1. However, according to Bernoulli's law of large numbers, the probability may be estimated by the frequency, that is, the probability that each bit is 1 may be represented by the proportion of the number of 1 in this bit stream. For example, 1000 may be represented by ¼, and 1100 may be represented by ½. In the embodiments of the present application, the pulse to be computed (a bit stream) output by the pulse output circuit may represent the decimal to be computed, and then the computing circuit performs stochastic computing according to the pulse to be computed. This stochastic computing circuit has dual characteristics of stimulation (duty cycle) and digits (logic values). Moreover, the stochastic circuit is a digital circuit, which is easy to integrate and transplant, thereby reducing the research and development cost.

In addition, the stochastic computing circuit may belong to the processor. In this case, there is no need for the stochastic computing circuit to access the memory during the computing process. Therefore, the bandwidth of the memory will not affect the computing efficiency of the stochastic computing circuit.

In summary, in the stochastic computing circuit provided by the embodiments of the present application, the pulse output circuit can output the pulse to be computed and the computing circuit can perform logic computing according to the duty cycle of the pulse to be computed. When certain bit in the pulse to be computed is wrong, the duty cycle of the pulse to be computed does not change significantly and thus the result of the logic computing does not change significantly. Therefore, the accuracy of the computing result output by the computing circuit is relatively high.

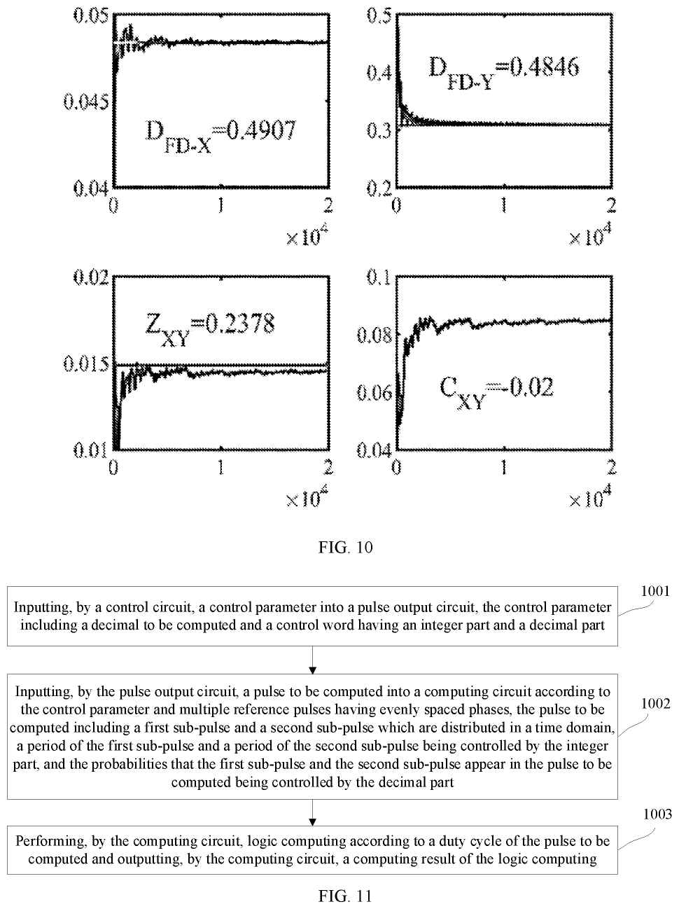

Table 1 below shows two application examples of the stochastic computing circuit shown in FIG. 8, wherein F_{X} represents the control word input into the first pulse output circuit by the control circuit, and F_{Y} represents the control word input into the second pulse output circuit by the control circuit. ξₓ represents a high-level parameter input into the first pulse output circuit by the control circuit, and ξ_{y} represents a high-level parameter input into the second pulse output circuit by the control circuit. {I=2, p=17, q=64}x represents {I, p, q} in the first pulse output circuit and {I=2, p=57, q=128}_{Y} represents {I, p, q} in the second pulse output circuit. T_{TAFX} represents the period of the first pulse to be computed output by the first pulse output circuit and T_{TAFY} represents the period of the second pulse to be computed output by the second pulse output circuit. D_{FD-X} represents the duty cycle (representing the decimal to be computed) of the first pulse to be computed output by the first pulse output circuit and D_{FD-Y} represents the duty cycle (representing the decimal to be computed) of the second pulse to be computed output by the second pulse output circuit. The more the correlation coefficient of the first pulse to be computed and the second pulse to be computed approaches 0, the more uncorrelated these two pulses are. It can be seen from table 1 that the correlation coefficients of these two pulses all approach 0. The results of example 1 are as shown in FIG. 9 and the results of example 2 are as shown in FIG. 10. The horizontal axis in these two graphs represents the number of Δs corresponding to the target sequence length. It should be noted that the target sequence length has a corresponding duration. The sampling circuit may acquire the result sequence having the target sequence length after sampling for this duration, which is equal to the product of the number of Δs corresponding to the target sequence length and Δ.

TABLE 1

| | Example 1 | Example 2 |
|---|---|---|
| Control parameter | F_{X} = 2.265625 = 2 + 17/64, ζ_{X} = 1 | F_{X} = 14.265625 = 14 + 17/64, ζ_{X} = 7 |
| | F_{Y} = 2.4453125 = 2 + 57/128, ζ_{Y} = 1 | F_{Y} = 14.4453125 = 14 + 57/128, ζ_{Y} = 7 |
| \|T_{TAFX} − | about 7% | about 1% |
| T_{TAFY}\|/T_{TAFX}*100% | | |
| {I, p, q} | {I = 2, p = 17, q = 64}_{X} | {I = 14, p = 17, q = 64}_{X} |
| | {I = 2, p = 57, q = 128}_{Y} | {I = 14, p = 57, q = 128}_{Y} |
| Iqp = q · I + p | Iqp_{X} = 145 | Iqp_{X} = 913 |
| | Iqp_{Y} = 313 | Iqp_{Y} = 1849 |
| \|Iqp_{X} − Iqp_{Y}\|/ | about 85% | about 51% |
| Iqp_{X} · 100% | | |
| Decimal to be | D_{FD-X} = 64/145 = | D_{FD-X} = 448/913 = |
| computed | 0.44137931034482758620689655172414 | 0.49069003285870755750273822562979 |
| | D_{FD-Y} = 128/313 = | D_{FD-Y} = 896/1849 = |
| | 0.40894568690095846645367412140575 | 0.48458626284478096268253109789075 |
| Theoretical | 0.18050016525283684036575961220668 | 0.23778164923818386777850375887739 |
| computing result | | |
| Actual computing | 0.1822 (computing accuracy of 1%, the | 0.2381 (computing accuracy Of 1%, the |
| result Z_{XY} | target sequence length corresponding to | target sequence length corresponding to |
| | 1509Δ) | 21Δ) |
| Correlation | −0.0341 (the target sequence length | −0.02(the target sequence length |
| coefficient | corresponding to 10000Δ) | corresponding to 200000Δ) |

Embodiments of the present application provide a stochastic computing method. The stochastic computing method may be used for any stochastic computing circuit provided by the embodiments of the present application. As shown in FIG. 11, the method includes the following steps.

In step 1001, a control parameter is input into a pulse output circuit by a control circuit, the control parameter including a control word having an integer part and a decimal part.

In step 1002, a pulse to be computed is input into a computing circuit by the pulse output circuit according to the control parameter and multiple reference pulses having evenly spaced phases. The pulse to be computed includes a first sub-pulse and a second sub-pulse which are distributed in a time domain, a period of the first sub-pulse and a period of the second sub-pulse are controlled by the integer part, and the probabilities that the first sub-pulse and the second sub-pulse appear in the pulse to be computed are controlled by the decimal part.

In step 1003, logic computing is performed by the computing circuit according to a duty cycle of the pulse to be computed and a computing result of the logic computing is output by the computing circuit.

In some embodiments, the control parameter further includes a high-level parameter ξ; and T_{HI_A}=T_{HI_B}=ξ*Δ, wherein

T_{HI_A} represents a duration of a high-level of the first sub-pulse; T_{HI_B} represents a duration of a high-level of the second sub-pulse; ξ is an integer, 1≤ξ≤I-1, and I represents the integer part; and Δ represents a phase difference between any two adjacent reference pulses among the multiple reference pulses.

In some embodiments, the stochastic computing circuit includes a plurality of pulse output circuits. Step 1001 includes: the control parameter corresponding to each of the pulse output circuits is input into the corresponding pulse output circuit by the control circuit. Step 1002 includes: the pulse to be computed is input into the computing circuit by each of the pulse output circuits according to the input control parameter and the multiple reference pulses having evenly spaced phases.

In some embodiments, the plurality of pulse output circuits includes a first pulse output circuit configured to input a first pulse to be computed into the computing circuit, and a second pulse output circuit configured to input a second pulse to be computed into the computing circuit, the first pulse to be computed being uncorrelated with the second pulse to be computed.

In some embodiments, the first pulse to be computed is independent of the second pulse to be computed.

In some embodiments, a target parameter of the first pulse to be computed and a target parameter of the second pulse to be computed are mutually prime; and

for any of the pulses to be computed, the target parameter of the pulse to be computed is q*I+p, p/q being equal to the decimal part and I representing the integer part.

In some embodiments, the stochastic computing circuit further includes: a sampling circuit and a clock circuit. both the computing circuit and the clock circuit are connected to the sampling circuit; and the sampling circuit is further connected to the control circuit.

The method further includes:
a target sequence length is input by the control circuit into the sampling circuit;
a clock signal is provided by the clock circuit to the sampling circuit;
a result sequence having the target sequence length is acquired by the sampling circuit by sampling the computing result output by the computing circuit according to the clock signal and the target sequence length; and
an indicator signal of a duty cycle of the result sequence is output by the sampling circuit.

In some embodiments, a duration of the pulse to be computed is T_{FD}=(q−p)*T_{A}+p*T_{B}, wherein

p/q is equal to the decimal part; T_{A}=I*·Δ, T_{A} represents the period of the first sub-pulse, I represents the integer part, and A represents a phase difference between any two adjacent reference pulses among the multiple reference pulses; and T_{B}=(I+1)*Δ, T_{B} representing the period of the second sub-pulse.

In some embodiments, p/q is a fraction in lowest terms of the decimal part.

In some embodiments, the integer part is greater than 16.

In some embodiments, the pulse output circuit includes: a first processing circuit, a second processing circuit and an output circuit. Both the first processing circuit and the output circuit are connected to the second processing circuit. Step 1002 includes:
a first control signal and a second control signal are output by the first processing circuit according to the control parameter;
an I-th reference pulse is selected from the multiple reference pulses by the second processing circuit according to the first control signal, a J-th reference pulse is selected from the multiple reference pulses by the second processing circuit according to the second control signal, and one of the I-th reference pulse and the J-th reference pulse is selected by the second processing circuit as an output pulse, 1≤I, and 1≤J; and
the pulse to be computed is output by the output circuit according to the output pulse of the second processing circuit.

In some embodiments, the logic computing includes at least one of addition, subtraction, multiplication, division, square root, and square.

The explanation of above respective steps may refer to corresponding descriptions regarding the embodiments of the stochastic computing circuit and embodiments are not repeated at the method side.

Embodiments of the present application further provide a chip. The chip includes any stochastic computing circuit provided by the embodiments of the present application. The chip may be a CPU, a GPU or the like.

Embodiment of the present application further provide an electronic device. The electronic device includes any chip provided by the embodiments of the present application. The electronic device may be a computer.

In the present disclosure, the terms “first” and “second” are merely for the purpose of description and should not be construed as indicating or implying relative importance. The term “a plurality of” means two or more, unless otherwise expressly provided.

The term “and/or” merely describes an association relationship of associated objects, and indicates the existence of three types of relationships. For example, A and/or B indicates: A exists alone, A and B exist simultaneously, and B exists alone. In addition, the character here “/” generally indicates that the associated objects are in an “or” relationship.

It should be noted that the different embodiments provided by the embodiments of the present application may refer to one another, which is not limited in the embodiments of the present application. The order of steps of the method embodiment provided in the embodiments of the present application may be adjusted properly and the steps may also be correspondingly increased or decreased according to the situation, and change methods that would be readily conceived by any person skilled in the art within the scope of the technology disclosed in the present application should fall within the scope of protection of the present application and thus will not be described here. The above descriptions are merely optional embodiments of the present application, and are not intended to limit the present application. Any modifications, equivalent replacements, improvements and the like made within the spirit and principles of the present application shall be included within the scope of protection of the present application.

1. A stochastic computing circuit, comprising a control circuit, a pulse output circuit and a computing circuit, wherein both the control circuit and the computing circuit are connected to the pulse output circuit;
the control circuit is configured to input a control parameter into the pulse output circuit, the control parameter comprising a control word having an integer part and a decimal part;
the pulse output circuit is configured to input a pulse to be computed into the computing circuit according to the control parameter and multiple reference pulses having evenly spaced phases, the pulse to be computed comprising at least one of a first sub-pulse and a second sub-pulse which are distributed in a time domain, a period of the first sub-pulse and a period of the second sub-pulse being controlled by the integer part, and probabilities that the first sub-pulse and the second sub-pulse appear in the pulse to be computed being controlled by the decimal part; and
the computing circuit is configured to perform logic computing according to a duty cycle of the pulse to be computed and output a computing result of the logic computing.

2. The stochastic computing circuit according to claim 1, wherein the control parameter further comprises a high-level parameter ξ; and T_{HI_A}=T_{HI_B}=ξ*Δ, wherein
T_{HI_A} represents a duration of a high-level of the first sub-pulse; T_{HI_B} represents a duration of a high-level of the second sub-pulse; is an integer, and 1≤ξ≤ I-1, wherein I represents the integer part; and A represents a phase difference between any two adjacent reference pulses among the multiple reference pulses.

3. The stochastic computing circuit according to claim 1, comprising a plurality of pulse output circuits, wherein
the control circuit is configured to input a control parameter corresponding to each of the pulse output circuits into a corresponding pulse output circuit.

4. The stochastic computing circuit according to claim 3, wherein the plurality of pulse output circuits comprises: a first pulse output circuit configured to input a first pulse to be computed into the computing circuit, and a second pulse output circuit configured to input a second pulse to be computed into the computing circuit; and
the first pulse to be computed is uncorrelated with the second pulse to be computed.

5. The stochastic computing circuit according to claim 4, wherein the first pulse to be computed and the second pulse to be computed are independent of each other.

6. The stochastic computing circuit according to claim 5, wherein a target parameter of the first pulse to be computed and a target parameter of the second pulse to be computed are mutually prime; and
for any pulse to be computed, the target parameter of the pulse to be computed is q*I+p, p/q being equal to the decimal part and I representing the integer part.

7. The stochastic computing circuit according to claim 1, further comprising: a sampling circuit and a clock circuit, wherein both the computing circuit and the clock circuit are connected to the sampling circuit; wherein the sampling circuit is further connected to the control circuit;
the control circuit is further configured to input a target sequence length into the sampling circuit;
the clock circuit is configured to provide a clock signal to the sampling circuit;
the sampling circuit is configured to acquire a result sequence having the target sequence length by sampling the computing result output by the computing circuit according to the clock signal and the target sequence length; and
the sampling circuit is further configured to output an indicator signal of a duty cycle of the result sequence.

8. The stochastic computing circuit according to claim 1, wherein a duration of the pulse to be computed T_{FD}=(q-p)*T_{A}+p*T_{B}; wherein
p/q is equal to the decimal part; T_{A}=I*Δ, T_{A} representing the period of the first sub-pulse, I representing the integer part, and A representing a phase difference between any two adjacent reference pulses among the multiple reference pulses; and T_{B}=(I+1)*Δ, T_{B} representing the period of the second sub-pulse.

9. The stochastic computing circuit according to claim 8, wherein p/q is a fraction in lowest terms of the decimal part.

10. The stochastic computing circuit according to claim 1, wherein the integer part is greater than 16.

11. The stochastic computing circuit according to claim 1, wherein the pulse output circuit comprises: a first processing circuit, a second processing circuit and an output circuit, wherein both the first processing circuit and the output circuit are connected to the second processing circuit;
the first processing circuit is configured to output a first control signal and a second control signal according to the control parameter;
the second processing circuit is configured to select an I-th reference pulse from the multiple reference pulses according to the first control signal, select a J-th reference pulse from the multiple reference pulses according to the second control signal, and select one of the I-th reference pulse and the J-th reference pulse as an output pulse, 1≤ I, and 1≤ J; and
the output circuit is configured to output the pulse to be computed according to the output pulse of the second processing circuit.

12. The stochastic computing circuit according to claim 1, wherein the logic computing comprises at least one of addition, subtraction, multiplication, division, square root, and square.

13. A stochastic computing method used for the stochastic computing circuit according to claim 1, the method comprising:
inputting, by the control circuit, the control parameter into the pulse output circuit, the control parameter comprising a control word having an integer part and a decimal part;
inputting, by the pulse output circuit, the pulse to be computed into the computing circuit according to the control parameter and the multiple reference pulses having evenly spaced phases, the pulse to be computed comprising at least one of the first sub-pulse and the second sub-pulse distributed in the time domain, and the periods of the first sub-pulse and the second sub-pulse being controlled by the integer part, and the probabilities that the first sub-pulse and the second sub-pulse appear in the pulse to be computed being controlled by the decimal part; and
performing, by the computing circuit, logic computing according to the duty cycle of the pulse to be computed and outputting, by the computing circuit, the computing result of the logic computing.

14. A chip, comprising the stochastic computing circuit according to claim 1.

15. An electronic device, comprising the chip according to claim 14.

16. The electronic device according to claim 15, wherein the control parameter further comprises a high-level parameter ξ; and T_{HI_A}=T_{HI_B}=ξ*Δ, wherein
T_{HI_A} represents a duration of a high-level of the first sub-pulse; T_{HI_B} represents a duration of a high-level of the second sub-pulse; is an integer, and 1≤ξ≤ I-1, wherein I represents the integer part; and A represents a phase difference between any two adjacent reference pulses among the multiple reference pulses.

17. The electronic device according to claim 15, wherein the stochastic computing circuit comprises a plurality of pulse output circuits, wherein
the control circuit is configured to input a control parameter corresponding to each of the pulse output circuits into a corresponding pulse output circuit.

18. The electronic device according to claim 17, wherein the plurality of pulse output circuits comprises: a first pulse output circuit configured to input a first pulse to be computed into the computing circuit, and a second pulse output circuit configured to input a second pulse to be computed into the computing circuit; and
the first pulse to be computed is uncorrelated with the second pulse to be computed.

19. The electronic device according to claim 18, wherein the first pulse to be computed and the second pulse to be computed are independent of each other.

20. The electronic device according to claim 19, wherein a target parameter of the first pulse to be computed and a target parameter of the second pulse to be computed are mutually prime; and
for any pulse to be computed, the target parameter of the pulse to be computed is q*I+p, p/q being equal to the decimal part and I representing the integer part.
